(19) United States
(12) Patent Application Publication
(10) Pub. No.: US 2005/0126091 A1
(43) Pub. Date: Jun. 16, 2005

(54) Impact resistant glass unit

(75) Inventors: Craig E. Sherrett, Pittsburgh, PA (US); Charles M. Wetmore, Pittsburgh, PA (US); James J. Cosharek, Rillton, PA (US)

Correspondence Address: FRASER MARTIN BUCHANAN MILLER LLC, 132C WEST SECOND STREET, PERRYSBURG, OH, 43551-1401, US

(73) Assignee: Kensington Windows, Inc., Vandergrift, PA (US)

(21) Appl. No.: 10/734,836

(22) Filed: Dec. 12, 2003

(51) Int. Cl. E06B 3/68; E06B 9/01

(52) U.S. Cl. 52/204.6

(57) ABSTRACT

An impact resistant glass structure having three spaced apart panes wherein an outermost pane is a monolithic glass sheet, a center pane is a plastic sheet such as a polycarbonate, and an innermost pane is a laminated glass having an annealed glass layer and a film layer such as polyester, the glass structure militating against penetration of the vertical plane when impacted by a projectile such as may occur during a wind storm.

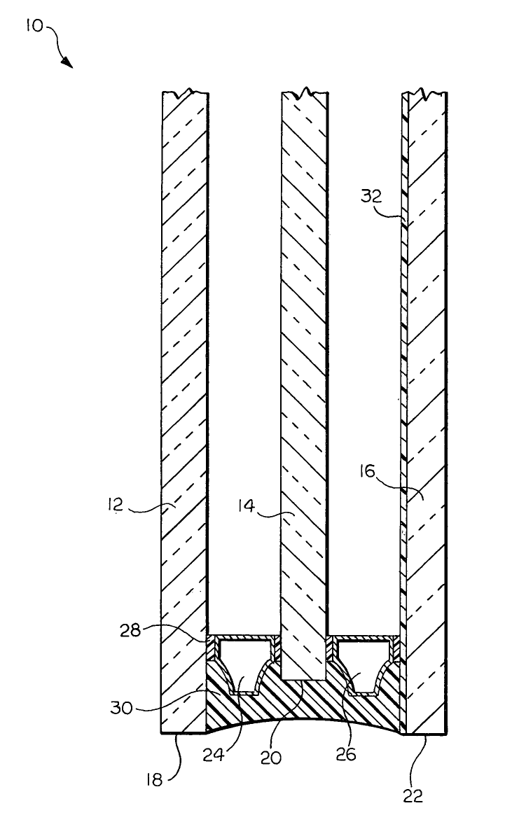

### FIELD OF THE INVENTION

The present invention relates to an impact resistant glass structure and more particularly to an impact resistant glass structure having three spaced apart panes wherein an outermost pane is a monolithic glass sheet, a center pane is a plastic sheet such as a polycarbonate, and an innermost pane is a laminated glass having an annealed glass layer and a film layer such as polyester.

### BACKGROUND OF THE INVENTION

Exterior windows are part of a building envelope, which essentially includes those elements that comprise an exterior of a building. As part of the building envelope, exterior windows are subjected to a variety of weather extremes. Accordingly, an increasing number of localities are increasing the structural standards applicable to exterior windows. In particular, many localities are adopting laws and building codes which include strenuous impact standards. The impact standards often require the exterior windows to withstand an impact of a missile or projectile driven by the high winds of a hurricane or a tornado. Even in the absence of hurricane conditions, it is often desirable to have an exterior window having high strength and durability.

Double-paned window glazing units are frequently employed in construction due to their favorable insulating properties. Such double glazed windows have advantageous thermal insulating properties because an air space exists between the two panes of glass. The air space acts as a thermal barrier. Such windows have a serious drawback however, in that they remain susceptible to being easily broken.

It would be desirable to produce an impact resistant glass structure having three distinct spaced apart layers which militates against penetration of the vertical plane when impacted by a projectile.

### SUMMARY OF THE INVENTION

Consistent and consonant with the present invention, an impact resistant glass unit having three distinct spaced apart layers which militates against penetration of the vertical plane when impacted by a projectile, has surprisingly been discovered.

The impact resistant glass structure comprises a generally planar glass first layer having an outer edge; a generally planar impact resistant plastic second layer spaced from and substantially parallel with the first layer, the second layer having an outer edge; a generally planar laminated glass third layer spaced from and substantially parallel with the first layer and the second layer, the third layer having an outer edge; a first spacer disposed between the first layer and the second layer adjacent the respective outer edges thereof; and a second spacer disposed between the second layer and the third layer adjacent the respective outer edges thereof, wherein the outer edge of the first layer, the outer edge of the second layer, and the outer edge of the third layer are adapted to be disposed in a window casing.

### BRIEF DESCRIPTION OF THE DRAWINGS

The above, as well as other objects, features, and advantages of the present invention will be understood from the detailed description of the preferred embodiments of the present invention with reference to the accompanying drawing, in which:

The drawing is a schematic fragmentary sectional elevational view of a portion of an impact resistant glass structure in accordance with the present invention.

### DETAILED DESCRIPTION OF THE PREFERRED EMBODIMENT

Referring to the drawing, there is shown generally at 10 a schematic sectional view of an impact resistant glass structure in accordance with the present invention. The glass structure 10 includes a first layer 12, a second layer 14, and a third layer 16. The first layer 12, the second layer 14, and the third layer 16 are spaced from and are substantially parallel with one another. In the embodiment shown, the first layer 12 is produced from an annealed glass having a low emissivity (low-E) material deposited on one surface thereof. It is understood that other glass types could be used without departing from the scope and spirit of the invention. An outer edge 18 of the first layer 12 is adapted to be installed in a window casing (not shown). In the embodiment shown, the space between each of the layers 12, 14, 16 is filled with a gas such as air, argon, krypton, or a blend of argon and krypton, for example, to militate against a fog or condensate forming on a surface of the layers 12, 14, 16.

The second layer 14 is disposed between the first layer 12 and the third layer 16. In the embodiment shown, an outer edge 20 of the second layer 14 is spaced inwardly from the outer edge 18 of the first layer 12. Typically, the second layer 14 is produced from a plastic having a greater impact resistance than glass such as a polycarbonate, a polymethyl methacrylate, and a polyethylene terepthalate, for example. One such plastic is sold by the General Electric Company under the trademark LEXAN MR10. It is understood that other plastic types could be used without departing from the scope and spirit of the invention.

An outer edge 22 of the third layer 16 extends to substantially the same extremity as the outer edge 18 of the first layer 12. Thus, the outer edge 18 of the first layer 12 and the outer edge 22 of the third layer 16 extend outwardly beyond the outer edge 20 of the second layer 14. The third layer 16 is produced from a laminated glass having a film 32 disposed on an inner surface thereof. Preferably, the film 32 is a plastic material such as polyester, for example. However, it is understood that other film materials could be used. It is also understood that the third layer 16 could be coated the inner surface as shown, an outer surface, both inner and outer surfaces, or alternatively, the third layer 16 could be formed as a laminated structure having the film 32 sandwiched between two juxtaposed layers of glass. In the embodiment shown, the third layer 16 is produced from an annealed glass. It is understood that other glass types could be used.

A first spacer 24 is disposed between the first layer 12 and the second layer 14 adjacent the respective outer edges 18, 20 thereof and a second spacer 26 is disposed between the second layer 14 and the third layer 16 adjacent the respective outer edges 20, 22 thereof. A first sealant layer 28 and a second sealant layer 30 are disposed around the first spacer 24 and the second spacer 26. The first sealant layer 28 is produced from a polyisobutylene material and the second sealant layer 30 is produced from polyurethane. It is understood that other thermoplastic polymers could be used.

In use, the first layer 12, the second layer 14, and the third layer 16 are installed in the window casing. The casing surrounds the outer edge 18, 20, 22 of the respective the layer 12, 14, 16. The first spacer 24 maintains a separation between the first layer 12 and the second layer 14. The second spacer 26 maintains a separation between the second layer 14 and the third layer 16. The first sealant layer 28 and the second sealant layer 30 hold the spacers 24, 26 in place and also provide a vapor barrier between the interstitial space between the layers 12, 14, 16 and the atmosphere. A desiccant material (not shown) can also be disposed in the interstitial space to absorb moisture and militate against fog or condensate forming on of a surface of the layers 12, 14, 16.

The glass structure 10 provides a thermal insulating structure, as well as an impact resistant structure. In the event a projectile is caused to impact the glass structure 10, the second layer 14 and the third layer 16 militate against a shattering and a complete failure of the glass structure 10, and militate against fragments being caused to become airborne causing injury to a bystander. The glass structure 10 of the embodiment shown is sufficiently strong to militate against penetration in impact tests. The spacers 24, 26, the first sealant layer 28, and the second sealant layer 30 also militate against a separation of the layers 12, 14, 16 in impact tests.

From the foregoing description, one ordinarily skilled in the art can easily ascertain the essential characteristics of this invention and, without departing from the spirit and scope thereof, can make various changes and modifications to the invention to adapt it to various usages and conditions.

1. An impact resistant glass structure comprising:
a generally planar glass first layer having an outer edge;
a generally planar impact resistant plastic second layer spaced from and substantially parallel with said first layer, said second layer having an outer edge;
a generally planar laminated glass third layer spaced from and substantially parallel with said first layer and said second layer, said third layer having an outer edge;
a first spacer disposed between said first layer and said second layer adjacent the respective outer edges thereof; and
a second spacer disposed between said second layer and said third layer adjacent the respective outer edges thereof, wherein the outer edge of said first layer, the outer edge of said second layer, and the outer edge of said third layer are adapted to be disposed in a window casing.

2. The structure according to claim 1, including a first sealant disposed between said first layer, said second layer, and said third layer adjacent the respective outer edges thereof.

3. The structure according to claim 2, wherein the first sealant is a polyisobutelene sealant.

4. The structure according to claim 2 including a second sealant disposed between said first layer, said second layer, and said third layer adjacent the respective outer edges thereof.

5. The structure according to claim 4 wherein at least one of the first sealant and the second sealant at least partially surround said first spacer and said second spacer.

6. The structure according to claim 4, wherein the second sealant is a polyurethane sealant.

7. The structure according to claim 1, wherein a gas filled air space is formed between at least one of said first layer and said second layer, and said second layer and said third layer.

8. The structure according to claim 1, wherein said first layer is an annealed glass

9. The structure according to claim 1, wherein said first layer has a low-E material deposited thereon.

10. The structure according to claim 1, wherein said second layer is a polycarbonate.

11. The structure according to claim 1, wherein said second layer is a polymethyl methacrylate.

12. The structure according to claim 1, wherein said second layer is a polyethylene terephthalate.

13. The structure according to claim 1, wherein the outer edge of said second layer is spaced inwardly from respective outer edges of said first layer and said third layer.

14. The structure according to claim 1, wherein said third layer is an annealed glass.
